(19) United States
(12) Patent Application Publication
(10) Pub. No.: US 2019/0077425 A1
(43) Pub. Date: Mar. 14, 2019

(54) RAILWAY VEHICLE VIBRATION DAMPING DEVICE

(71) Applicant: KYB CORPORATION, Tokyo (JP)

(72) Inventors: Takayuki OGAWA, Tokyo (JP); Jun AOKI, Tokyo (JP)

(73) Assignee: KYB CORPORATION, Tokyo (JP)

(21) Appl. No.: 16/083,237

(22) PCT Filed: Apr. 19, 2017
(86) PCT No.: PCT/JP2017/015733

§ 371 Date: Sep. 7, 2018

(30) Foreign Application Priority Data
Jul. 29, 2016 (JP) 2016-149989

(51) Int. Cl. B61F 5/24; F15B 11/028; F15B 13/02; F15B 15/14; F15B 21/00

(52) U.S. Cl. CPC B61F 5/245; F15B 11/028; F15B 13/021; F15B 15/149; F15B 2211/8616; F15B 13/027; F15B 2211/30505; F15B 2211/7058; F15B 2211/75; F15B 21/008

(57) ABSTRACT

A railway vehicle vibration damping device includes an actuator and a control unit controlling a pump and controls a rotation speed of the pump based on a vehicle speed of a railway vehicle.

### TECHNICAL FIELD

The present invention relates to a railway vehicle vibration damping device.

### BACKGROUND ART

Conventionally, among railway vehicle vibration damping devices, for example, a vibration damping device which is used while being interposed between a vehicle body and a truck in order to suppress a horizontal vibration of the vehicle body in a railway vehicle traveling direction is known.

More specifically, for example, as disclosed in JP 2010-65797 A, the railway vehicle vibration damping device includes a cylinder, a piston which is slidably inserted into the cylinder to define a rod side chamber and a piston side chamber inside the cylinder, an actuator which includes a rod inserted into the cylinder and connected to the piston and is interposed between a vehicle body and a truck, a tank, a first opening and closing valve which is provided in the course of a first passage communicating the rod side chamber with the piston side chamber, a second opening and closing valve which is provided in the course of a second passage communicating the piston side chamber with the tank, a pump which supplies hydraulic oil to the rod side chamber, a discharge passage which connects the rod side chamber to the tank, and a variable relief valve which is provided in the course of the discharge passage and is able to change a valve opening pressure, and is able to exert a thrust in both expansion and contraction operations by driving the pump, the first opening and closing valve, the second opening and closing valve, and the variable relief valve. Accordingly, the vibration of the vehicle body is suppressed by the thrust.

### SUMMARY OF THE INVENTION

The conventional railway vehicle vibration damping device drives the pump at a constant rotation speed (the number of rotations per unit time) and appropriately drives the first opening and closing valve, the second opening and closing valve, and the variable relief valve in accordance with the vibration state of the vehicle body. Accordingly, a thrust for suppressing the vibration of the vehicle body using the hydraulic pressure is obtained and hence the vibration of the railway vehicle is suppressed.

The conventional railway vehicle vibration damping device does not have any problem in the vibration suppressing function, but has a problem that a passenger recognizes noise.

That is, since the railway vehicle vibration damping device is attached to the vehicle body, sound such as a vibration sound of a motor for driving the pump, a vibration sound caused by the pulsation or the like of the pump, and a vibration sound caused by the resonance of the actuator is transmitted to the vehicle body. The sound transmitted to the vehicle body is echoed inside the vehicle while the vehicle body itself becomes a speaker and hence a passenger inside the vehicle recognizes that sound as noise.

When the rotation speed of the pump is decreased due to this annoying noise, the discharge flow amount becomes insufficient and the thrust of the actuator also decreases. As a result, the vibration of the vehicle body cannot be sufficiently suppressed.

An object of the invention is to provide a railway vehicle vibration damping device which does not impair a vehicle body vibration suppressing effect and prevents a passenger from recognizing noise.

A railway vehicle vibration damping device of the present invention includes: an actuator which includes a cylinder body expanding or contracting by supply of a hydraulic fluid and a pump supplying the hydraulic fluid to the cylinder body and is provided in a railway vehicle; and a control unit which controls the pump, wherein the control unit controls a rotation speed of the pump based on a vehicle speed of the railway vehicle.

### BRIEF DESCRIPTION OF DRAWINGS

FIG. 1 is a schematic plan view of a railway vehicle equipped with a railway vehicle vibration damping device according to an embodiment.

FIG. 2 is a circuit diagram of an actuator of the railway vehicle vibration damping device of the embodiment.

FIG. 3 is a control block diagram of a control unit of the railway vehicle vibration damping device of the embodiment.

FIG. 4 is a graph showing a relationship between a vehicle speed and a pump rotation speed.

FIG. 5 is a flowchart illustrating an example of a sequence of determining a rotation speed.

FIG. 6 is a graph showing flow characteristics of an electromagnetic relief valve.

### DESCRIPTION OF EMBODIMENTS

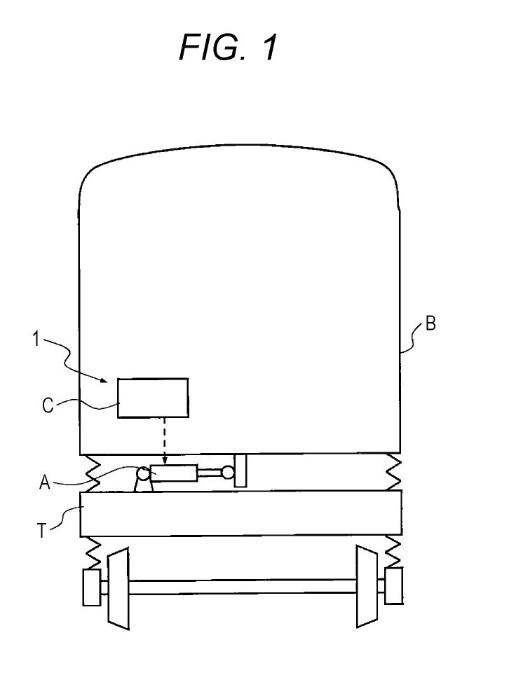

Hereinafter, the invention will be described based on an embodiment illustrated in the drawings. In this example, a railway vehicle vibration damping device 1 of the embodiment is used as a vibration damping device of a vehicle body B of the railway vehicle and includes an actuator A installed between a truck T and the vehicle body B and a control unit C as illustrated in FIG. 1. Then, the railway vehicle vibration damping device 1 of this example is configured to suppress a vibration in a horizontal and lateral direction of the vehicle body B in a vehicle traveling direction by a thrust exerted by the actuator A.

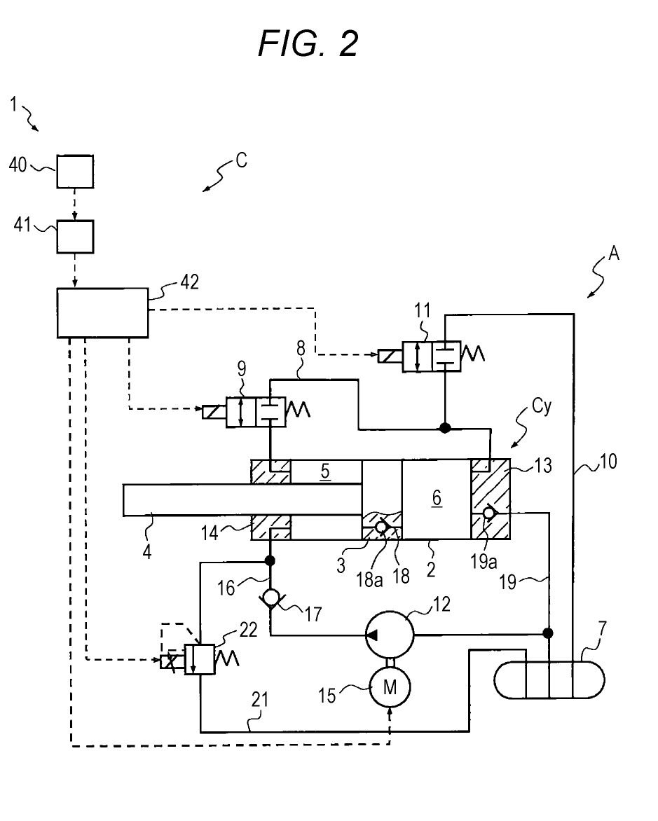

In this example, as illustrated in FIG. 2, the actuator A includes a tank 7, a first opening and closing valve 9 which is provided in the course of a first passage 8 communicating a rod side chamber 5 with a piston side chamber 6, a second opening and closing valve 11 which is provided in the course of a second passage 10 communicating the piston side chamber 6 with the tank 7, and a pump 12 which supplies hydraulic oil to the rod side chamber 5 in addition to a cylinder body Cy including a cylinder 2 connected to one of a vehicle body B and a truck T of a railway vehicle, a piston 3 slidably inserted into the cylinder 2, a rod 4 inserted into the cylinder 2 and connected to the piston 3 and the other of the truck T and the vehicle body B, and the rod side chamber 5 and the piston side chamber 6 defined inside the cylinder 2 by the piston 3 and is configured as a single rod type actuator. Further, in this example, the rod side chamber 5 and the piston side chamber 6 are filled with hydraulic oil which is a hydraulic fluid and the tank 7 is filled with a gas other than the hydraulic oil. Additionally, there is no need to pressurize the inside of the tank 7 by particularly compressing a gas filled therein. Further, the hydraulic fluid may be another liquid other than the hydraulic oil.

Then, basically, the cylinder body Cy is made to expand when the pump 12 is driven while the first opening and closing valve 9 communicates with the first passage 8 and the second opening and closing valve 11 is closed and the cylinder body Cy is made to contract when the pump 12 is driven while the second opening and closing valve 11 communicates with the second passage 10 and the first opening and closing valve 9 is closed.

Hereinafter, components of the actuator A will be described in detail. The cylinder 2 has a cylindrical shape, the right end thereof in FIG. 2 is blocked by a lid 13, and the left end thereof in FIG. 2 is attached with an annular rod guide 14. Further, the rod 4 movably inserted into the cylinder 2 is slidably inserted into the rod guide 14. One end of the rod 4 protrudes to the outside of the cylinder 2 and the other end inside the cylinder 2 is connected to the piston 3 slidably inserted into the cylinder 2.

Additionally, a gap between the outer periphery of the rod guide 14 and the cylinder 2 is sealed by a seal member (not illustrated) and hence the inside of the cylinder 2 is maintained in a hermetic state. Then, the rod side chamber 5 and the piston side chamber 6 defined inside the cylinder 2 by the piston 3 are filled with hydraulic oil as described above.

Further, in the case of the cylinder body Cy, the cross-sectional area of the rod 4 is set to a half of the cross-sectional area of the piston 3 and the pressure receiving area on the side of the rod side chamber 5 in the piston 3 becomes a half of the pressure receiving area on the side of the piston side chamber 6. Thus, when the pressure of the rod side chamber 5 is set to be the same during the expansion operation and the contraction operation, the thrusts generated by both expansion and contraction operations are the same and hence the hydraulic oil amounts against the displacement amount of the cylinder body Cy are also the same for both expansion and contraction operations.

Specifically, since the rod side chamber 5 communicates with the piston side chamber 6 at the time of expanding the cylinder body Cy, the pressure inside the rod side chamber 5 becomes the same as the pressure inside the piston side chamber 6 and the actuator A generates a thrust obtained by multiplying the pressure by a difference between a pressure receiving area on the side of the rod side chamber 5 and a pressure receiving area on the side of the piston side chamber 6 of the piston 3. In contrast, since the communication between the rod side chamber 5 and the piston side chamber 6 is disconnected and the piston side chamber 6 communicates with the tank 7 at the time of contracting the cylinder body Cy, the actuator A generates a thrust obtained by multiplying the pressure inside the rod side chamber 5 by the pressure receiving area on the side of the rod side chamber 5 in the piston 3. In brief, the thrust generated by the actuator A becomes a value obtained by multiplying the pressure of the rod side chamber 5 by a half of the cross-sectional area of the piston 3 in both expansion and contraction operations. Thus, the pressure of the rod side chamber 5 may be controlled in both expansion and contraction operations at the time of controlling the thrust of the actuator A. Further, in the actuator A of this example, since the pressure receiving area on the side of the rod side chamber 5 of the piston 3 is set to a half of the pressure receiving area on the side of the piston side chamber 6, the pressure of the rod side chamber 5 becomes the same in the expansion and contraction operations at the time of generating the same thrust in both expansion and contraction operations and hence the control is simple. In addition, since the amount of the hydraulic oil with respect to the displacement amount is the same, there is an advantage that the responsiveness at both expansion and contraction operations is the same. Additionally, it is possible to control the thrust at both expansion and contraction operations of the actuator A by the pressure of the rod side chamber 5 even when the pressure receiving area on the side of the rod side chamber 5 in the piston 3 is not set to a half of the pressure receiving area on the side of the piston side chamber 6.

Returning to the description, the lid 13 which blocks the left end of the rod 4 and the right end of the cylinder 2 in FIG. 2 is provided with an attachment portion (not illustrated) and the actuator A can be interposed between the truck T and the vehicle body B of the railway vehicle.

Then, the rod side chamber 5 and the piston side chamber 6 communicate with each other by the first passage 8 and the first opening and closing valve 9 is provided in the course of the first passage 8. The first passage 8 communicates the rod side chamber 5 and the piston side chamber 6 outside the cylinder 2, but may be provided in the piston 3.

The first opening and closing valve 9 is configured as an electromagnetic opening and closing valve and includes a communication position in which the first passage 8 is opened so that the rod side chamber 5 communicates with the piston side chamber 6 and an interruption position in which the first passage 8 is interrupted so that the communication between the rod side chamber 5 and the piston side chamber 6 is disconnected. Then, the first opening and closing valve 9 selects the communication position when a current is supplied thereto and selects the interruption position when a current is not supplied thereto.

Next, the piston side chamber 6 and the tank 7 communicate with each other by the second passage 10 and the second opening and closing valve 11 is provided in the course of the second passage 10. The second opening and closing valve 11 is configured as an electromagnetic opening and closing valve and includes a communication position in which the second passage 10 is opened so that the piston side chamber 6 communicates with the tank 7 and an interruption position in which the second passage 10 is interrupted so that the communication between the piston side chamber 6 and the tank 7 is disconnected. Then, the second opening and closing valve 11 selects the communication position when a current is supplied thereto and selects the interruption position when a current is not supplied thereto.

The pump 12 is configured as a pump which is driven by a motor 15 and discharges hydraulic oil only in one direction. Then, a discharge port of the pump 12 communicates with the rod side chamber 5 by a supply passage 16 and a suction port thereof communicates with the tank 7. Here, when the pump 12 is driven by the motor 15, the hydraulic oil is sucked from the tank 7 and the hydraulic oil is supplied to the rod side chamber 5.

As described above, since the pump 12 discharges the hydraulic oil only in one direction, there is no need to switch the rotation direction. For this reason, since there is no problem that the discharge amount at the time of switching the rotation changes, a cheap gear pump or the like can be used. Further, since the rotation direction of the pump 12 is the same at all times, high responsiveness for switching the rotation is not required also in the motor 15 which is a drive source for driving the pump 12 and hence a cheap one can be used as the motor 15. Additionally, a check valve 17 which prevents a reverse flow of the hydraulic oil from the rod side chamber 5 to the pump 12 is provided in the course of the supply passage 16.

Further, the actuator A of this example includes a discharge passage 21 which connects the rod side chamber 5 and the tank 7 and an electromagnetic relief valve 22 which is provided in the course of the discharge passage 21 to change a valve opening pressure.

In this example, the electromagnetic relief valve 22 is configured as a proportional electromagnetic relief valve, is provided in the course of the discharge passage 21, and can adjust the valve opening pressure in response to the supplied current amount. Here, the valve opening pressure becomes minimal when the current amount becomes maximal and the valve opening pressure becomes maximal when the current is not supplied.

In this way, when the discharge passage 21 and the electromagnetic relief valve 22 are provided, it is possible to adjust the pressure inside the rod side chamber 5 to the valve opening pressure of the electromagnetic relief valve 22 and to control the thrust of the actuator A by the amount the current supplied to the electromagnetic relief valve 22 at the time of expanding and contracting the cylinder body Cy. When the discharge passage 21 and the electromagnetic relief valve 22 are provided, sensors necessary for adjusting the thrust of the actuator A are not needed and the motor 15 does not need to be controlled with high accuracy in order to adjust the discharge flow amount of the pump 12. Thus, the railway vehicle vibration damping device 1 becomes cheap and can construct a reliable system in hardware and software.

Additionally, when the proportional electromagnetic relief valve which changes the valve opening pressure in a proportional manner by the current amount to the electromagnetic relief valve 22 is used, the valve opening pressure can be simply controlled. However, the valve is not limited to the proportional electromagnetic relief valve as long as the valve is the electromagnetic relief valve capable of adjusting the valve opening pressure.

Then, in the electromagnetic relief valve 22, there is an excessive input in the expansion and contraction direction to the cylinder body Cy regardless of the opened and closed states of the first opening and closing valve 9 and the second opening and closing valve 11. Here, when the pressure of the rod side chamber 5 exceeds the valve opening pressure, the discharge passage 21 is opened. In this way, since the electromagnetic relief valve 22 discharges the pressure inside the rod side chamber 5 to the tank 7 when the pressure of the rod side chamber 5 becomes equal to or larger than the valve opening pressure, it is possible to protect the whole system of the actuator A by preventing an excessive pressure inside the cylinder 2. Thus, when the discharge passage 21 and the electromagnetic relief valve 22 are provided, the system can be also protected.

Further, the actuator A of the embodiment includes a rectifier passage 18 which allows only the flow of the hydraulic oil from the piston side chamber 6 to the rod side chamber 5 and a suction passage 19 which allows only the flow of the hydraulic oil from the tank 7 to the piston side chamber 6. Thus, in the actuator A of this example, when the cylinder body Cy expands and contracts while the first opening and closing valve 9 and the second opening and closing valve 11 are closed, the electromagnetic relief valve 22 gives a resistance to the flow of the hydraulic oil extruded from the inside of the cylinder 2 and hence the actuator A serves as a uniflow type damper.

More specifically, the rectifier passage 18 communicates the piston side chamber 6 with the rod side chamber 5 and is set as a one-way passage which allows only the flow of the hydraulic oil from the piston side chamber 6 to the rod side chamber 5 since a check valve 18a is provided in the course thereof. Further, the suction passage 19 communicates the tank 7 with the piston side chamber 6 and is set as a one-way passage which allows only the flow of the hydraulic oil from the tank 7 to the piston side chamber 6 while a check valve 19a is provided in the course thereof. Additionally, the rectifier passage 18 can be integrated with the first passage 8 when the interruption position of the first opening and closing valve 9 is set as the check valve and the suction passage 19 can be also integrated with the second passage 10 when the interruption position of the second opening and closing valve 11 is set as the check valve.

In the actuator A with such a configuration, even when the first opening and closing valve 9 and the second opening and closing valve 11 select the interruption positions, the rod side chamber 5, the piston side chamber 6, and the tank 7 communicate with one another by the rectifier passage 18, the suction passage 19, and the discharge passage 21. Further, the rectifier passage 18, the suction passage 19, and the discharge passage 21 are set as one-way passages. Thus, when the cylinder body Cy expands or contracts by the external force, the hydraulic oil is essentially discharged from the cylinder 2 and is returned to the tank 7 through the discharge passage 21. Then, the hydraulic oil which is insufficient in the cylinder 2 is supplied from the tank 7 into the cylinder 2 through the suction passage 19. Since the electromagnetic relief valve 22 serves as a resistance with respect to the flow of the hydraulic oil to adjust the pressure inside the cylinder 2 to the valve opening pressure, the actuator A serves as a passive uniflow type damper.

Further, in the case of a failure in which a current cannot be supplied to each of components of the actuator A, each of the first opening and closing valve 9 and the second opening and closing valve 11 selects the interruption position and the electromagnetic relief valve 22 serves as a pressure control valve in which the valve opening pressure is fixed to maximum. Thus, the actuator A automatically serves as a passive damper in the case of the failure.

Next, when a thrust in a desired expansion direction is exerted on the actuator A having the above-described configuration, the control unit C basically sets the second opening and closing valve 11 to the interruption position while supplying the hydraulic oil from the pump 12 into the cylinder 2 with the rotation of the motor 15 and setting the first opening and closing valve 9 of the actuator A to the communication position. With such a configuration, the rod side chamber 5 communicates with the piston side chamber 6 and the hydraulic oil is supplied from the pump 12 to both chambers so that the piston 3 is pressed leftward in FIG. 2 and the actuator A exerts a thrust in the expansion direction. When the pressure inside the rod side chamber 5 and the pressure inside the piston side chamber 6 exceed the valve opening pressure of the electromagnetic relief valve 22, the electromagnetic relief valve 22 is opened so that the hydraulic oil is discharged to the tank 7 through the discharge passage 21. Thus, the pressure inside the rod side chamber 5 and the pressure inside the piston side chamber 6 are controlled at the valve opening pressure of the electromagnetic relief valve 22 determined by the current amount given to the electromagnetic relief valve 22. Then, the actuator A exerts a thrust in the expansion direction of a value obtained by multiplying the pressure inside the rod side chamber 5 and the pressure inside the piston side chamber 6 controlled by the electromagnetic relief valve 22 by a difference in pressure receiving area between the piston side chamber 6 and the rod side chamber 5 of the piston 3.

In contrast, when a thrust in a desired contraction direction is exerted on the actuator A, the control unit C sets the second opening and closing valve 11 to the communication position while supplying the hydraulic oil from the pump 12 into the rod side chamber 5 with the rotation of the motor 15 and setting the first opening and closing valve 9 of the actuator A to the interruption position. In this way, since the hydraulic oil is supplied from the pump 12 to the rod side chamber 5 while the piston side chamber 6 communicates with the tank 7, the piston 3 is pressed rightward in FIG. 2 and the actuator A exerts a thrust in the contraction direction. Then, when the current amount of the electromagnetic relief valve 22 is adjusted as described above, the actuator A exerts a thrust in the contraction direction obtained by multiplying the pressure receiving area on the side of the rod side chamber 5 in the piston 3 by the pressure inside the rod side chamber 5 controlled by the electromagnetic relief valve 22.

Further, the actuator A can serve as the actuator and also serve as the damper only by opening and closing the first opening and closing valve 9 and the second opening and closing valve 11 regardless of the driving state of the motor 15. Further, since the tedious and steep switching operations of the first opening and closing valve 9 and the second opening and closing valve 11 are not necessary at the time of switching the actuator A from the actuator to the damper, it is possible to provide a system with high responsiveness and reliability.

Additionally, since the actuator A of this example is set to a single rod type, a stroke length is easily ensured and the entire length of the actuator is shortened as compared with a dual rod type actuator. Accordingly, mountability to the railway vehicle is improved.

Further, the flow of the hydraulic oil in accordance with the supply of the hydraulic oil from the pump 12 and the expansion and contraction operations of the actuator A of this example sequentially passes through the rod side chamber 5 and the piston side chamber 6 and finally returns to the tank 7. For that reason, even when a gas is mixed in the rod side chamber 5 or the piston side chamber 6, the gas is independently discharged to the tank 7 by the expansion and contraction operations of the cylinder body Cy. Accordingly, it is possible to prevent deterioration of responsiveness at the time of generating the thrust. Thus, since there is no need to perform a troublesome assembly in oil or in vacuum to highly accurately degas the hydraulic oil at the time of manufacturing the actuator A, it is possible to improve productivity and to decrease manufacturing cost. Further, even when a gas is mixed in the rod side chamber 5 or the piston side chamber 6, the gas is independently discharged to the tank 7 by the expansion and contraction operations of the cylinder body Cy. Accordingly, since there is no need to frequently perform maintenance for recovering the performance, it is possible to reduce a burden on effort and cost in maintenance.

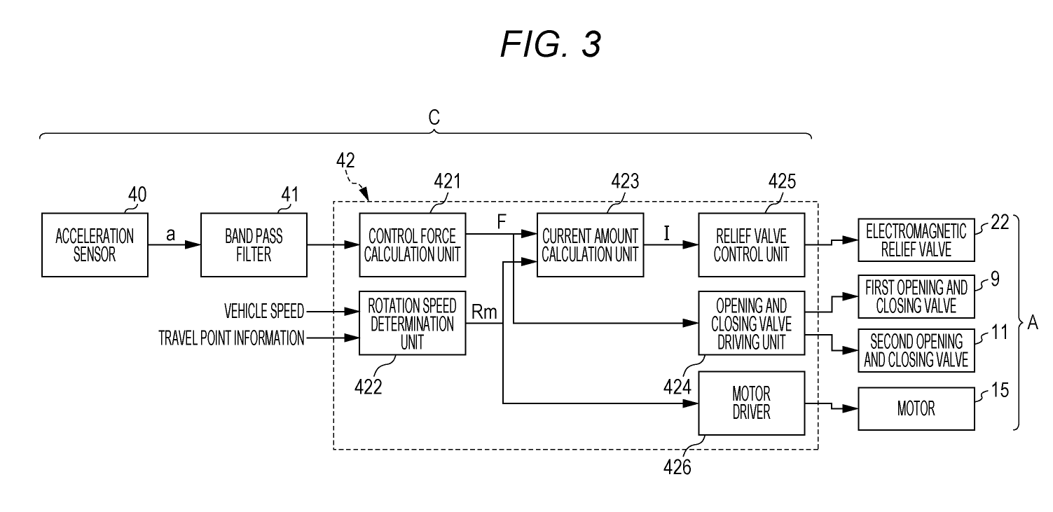

Next, as illustrated in FIGS. 2 and 3, the control unit C includes an acceleration sensor 40 which detects the lateral acceleration a in the horizontal lateral direction of the vehicle body B in the vehicle traveling direction, a band pass filter 41 which removes noise, a drift element, or a normal acceleration in a curve included in the lateral acceleration a, and a control processing unit 42 which processes the lateral acceleration a filtered by the band pass filter 41 and outputs a control command to the motor 15, the first opening and closing valve 9, the second opening and closing valve 11, and the electromagnetic relief valve 22 of the actuator A and controls the thrust of the actuator A. Additionally, since the normal acceleration in a curve included in the lateral acceleration a is removed by the band pass filter 41, it is possible to suppress only the vibration which deteriorates the ride comfort.

As illustrated in FIG. 3, the control processing unit 42 includes a control force calculation unit 421 which obtains a control force F corresponding to the thrust to be generated by the actuator A based on the lateral acceleration a detected by the acceleration sensor 40, a rotation speed determination unit 422 which obtains a rotation speed Rm of the pump 12 based on the travel point information and the vehicle speed received from a vehicle monitor (not illustrated) of the railway vehicle, a current amount calculation unit 423 which obtains a current amount I supplied to the electromagnetic relief valve 22 based on the control force F and the rotation speed Rm, an opening and closing valve driving unit 424 which switches the driving of the first opening and closing valve 9 and the second opening and closing valve 11 by receiving an input of the control force F, a relief valve control unit 425 which controls a current amount supplied to the electromagnetic relief valve 22 by receiving the input of the current amount I, and a motor driver 426 which controls the motor 15 by receiving the input of the rotation speed Rm.

In this example, the control force calculation unit 421 is configured as a H∞ controller and obtains the control force F indicating the thrust to be output from the actuator A in order to suppress the vibration of the vehicle body B from the lateral acceleration a. In addition, positive and negative signs are given to the control force F depending on the direction and the sign indicates the direction of the thrust to be output from the actuator A. When the opening and closing valve driving unit 424 receives the input of the control force F, the supply of the current to the first opening and closing valve 9 and the second opening and closing valve 11 is allowed or stopped in response to the sign of the control force F so that the valves are opened or closed. More specifically, when the expansion direction of the actuator A is set to a positive direction and the contraction direction thereof is set to a negative direction, the opening and closing valve driving unit 424 is operated as follows. When the sign of the control force F is positive, since the thrust exerting direction of the actuator A is the expansion direction, the opening and closing valve driving unit 424 sets the second opening and closing valve 11 to the interruption position while setting the first opening and closing valve 9 to the communication position. Then, the hydraulic oil is supplied from the pump 12 to both of the rod side chamber 5 and the piston side chamber 6 so that the actuator A exerts a thrust in the expansion direction. Meanwhile, when the sign of the control force F is negative, since the thrust exerting direction of the actuator A is the contraction direction, the opening and closing valve driving unit 424 sets the second opening and closing valve 11 to the communication position while setting the first opening and closing valve 9 to the interruption position. Then, since the hydraulic oil is supplied from the pump 12 only to the rod side chamber 5 so that the rod side chamber 5 communicates with the tank 7, the actuator A exerts a thrust in the contraction direction.

Additionally, in this example, the control force calculation unit 421 obtains the control force F only by the lateral acceleration a. However, the control force F may be obtained in such a manner that the control force for suppressing the sway of the vehicle body B and the control force for suppressing the yaw thereof are separately obtained based on the sway acceleration and the yaw acceleration of the vehicle body B and the control forces are added.

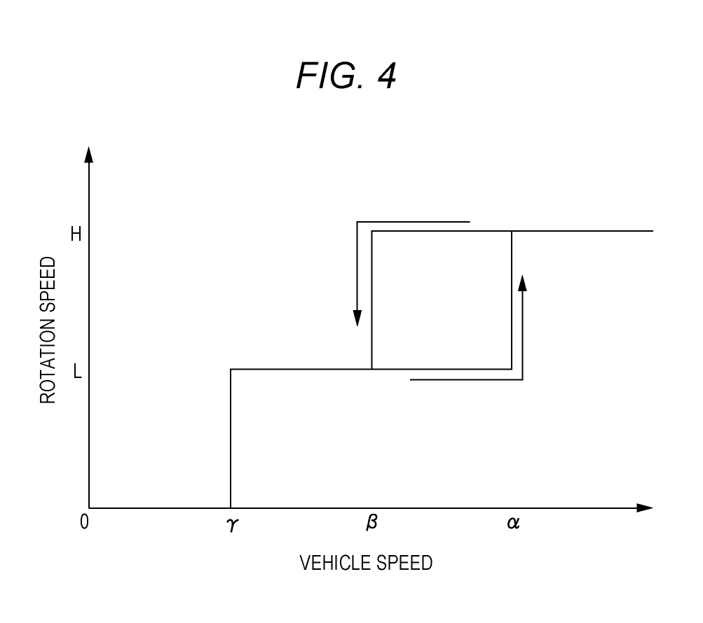

The rotation speed determination unit 422 first obtains a rotation speed Rmv of the pump 12 based on the vehicle speed of the railway vehicle input from the vehicle monitor. Then, the rotation speed determination unit 422 finally determines the rotation speed Rm of the pump 12 by the travel point information of the railway vehicle input from the vehicle monitor. First, a method of obtaining the rotation speed Rmv from the vehicle speed will be described. In this example, the rotation speed determination unit 422 determines the rotation speed Rmv based on the vehicle speed by selecting any one of two speeds of a low rotation speed L and a high rotation speed H higher than the low rotation speed L set in advance. Specifically, the rotation speed determination unit 422 changes the rotation speed of the pump 12 based on a first threshold value α set in advance for the vehicle speed and a second threshold value β smaller than the first threshold value α. As shown in FIG. 4, the rotation speed determination unit 422 switches the rotation speed Rmv of the pump 12 from the low rotation speed L to the high rotation speed H when the vehicle speed changes from a value smaller than the first threshold value α to a value equal to or larger than the first threshold value α in a case in which the low rotation speed L is selected. Further, as shown in FIG. 4, the rotation speed determination unit 422 switches the rotation speed Rmv of the pump 12 from the high rotation speed H to the low rotation speed L when the vehicle speed changes from a value equal to or larger than the second threshold value β set to a value smaller than the first threshold value α to a value smaller than the second threshold value β in a case in which the high rotation speed H is selected. Additionally, as shown in FIG. 4, when the vehicle speed is equal to or lower than a control ON speed γ smaller than the first threshold value α and the second threshold value β, the control of the actuator A is not started and hence the rotation speed Rmv of the pump 12 becomes zero. Further, in this example, the rotation speed determination unit 422 receives the input of the vehicle speed from the vehicle monitor, but may receive the vehicle speed from the vehicle speed sensor by providing the vehicle speed sensor.

Additionally, the first threshold value α is desirably set to a value of about 60% to 80% of a maximum speed in a high-speed railway of which the maximum speed equal to or higher than 200 km/h and is set to a range decreased from a maximum speed by 30 km/h to 50 km/h in a low-speed railway of which the maximum speed is lower than 200 km/h. Additionally, an acceleration section is set in a railroad line, but the first threshold value α may be set in the range between the maximum speed of the acceleration section and the speed limit before the acceleration section. Further, the second threshold value β is set to a value smaller than the first threshold value α. However, the second threshold value β may be set to a value smaller by 20 km/h or so than the first threshold value α in the high-speed railway and may be set to a value smaller by 10 km/h or so than the first threshold value α in the low-speed railway.

In this way, the rotation speed determination unit 422 of this example determines whether to switch the low rotation speed L to the high rotation speed H based on the first threshold value α when the vehicle speed rises. Further, the rotation speed determination unit 422 of this example determines whether to switch the high rotation speed H to the low rotation speed L based on the second threshold value β smaller than the first threshold value α when the vehicle speed falls. Thus, a change in the rotation speed Rmv of the pump 12 has hysteresis with respect to the vehicle speed. In this configuration, even when the vehicle speed changes oscillatingly in the vicinity of the first threshold value α or the second threshold value β, hunting in which the low rotation speed L and the high rotation speed H are switched at a high frequency does not occur.

However, when the hunting does not need to be suppressed, the rotation speed determination unit 422 may switch the low rotation speed L and the high rotation speed H only by the determination on whether the vehicle speed is equal to or larger than the first threshold value α.

As described above, the rotation speed determination unit 422 selects any one of the low rotation speed L and the high rotation speed H by the vehicle speed, obtains the rotation speed Rmv based on the vehicle speed, and then determines the rotation speed Rm based on the travel point information. Hereinafter, a method of determining the rotation speed Rm based on the travel point information will be described.

The rotation speed determination unit 422 sets the high rotation speed H to the rotation speed Rm when the received travel point is within a section (a vibration suppression emphasis section) of an orbit which is assumed such that the flow amount necessary for the cylinder body Cy increases. Specifically, in the vibration suppression emphasis section, a section with a deviation in the orbit, a point section, a curve section, and a tunnel section are specified in advance. When the railway vehicle travels in such a section, the vehicle body B is largely vibrated. For this reason, since it is desirable to damp the vibration of the vehicle body B by exerting a large thrust from the actuator A regardless of the vehicle speed of the railway vehicle, the rotation speed determination unit 422 selects the high rotation speed H to be the rotation speed Rm. Thus, when the travel point is the vibration suppression emphasis section, the rotation speed determination unit 422 determines the high rotation speed H as the final rotation speed Rm regardless of whether the rotation speed Rmv based on the vehicle speed is any one of the low rotation speed L and the high rotation speed H. Meanwhile, when the travel point is not the vibration suppression emphasis section, the rotation speed determination unit 422 sets the rotation speed Rmv obtained based on the vehicle speed as the final rotation speed Rm. That is, in a case in which the travel point is not the vibration suppression emphasis section, the rotation speed Rm is set to the low rotation speed L when the rotation speed Rmv is the low rotation speed L and the rotation speed Rm is set to the high rotation speed H when the rotation speed Rmv is the high rotation speed H. Additionally, in this example, the rotation speed determination unit 422 receives the input of the travel point information from the vehicle monitor, but may receive the travel point information of the railway vehicle from a global positioning system (GPS) by providing the GPS.

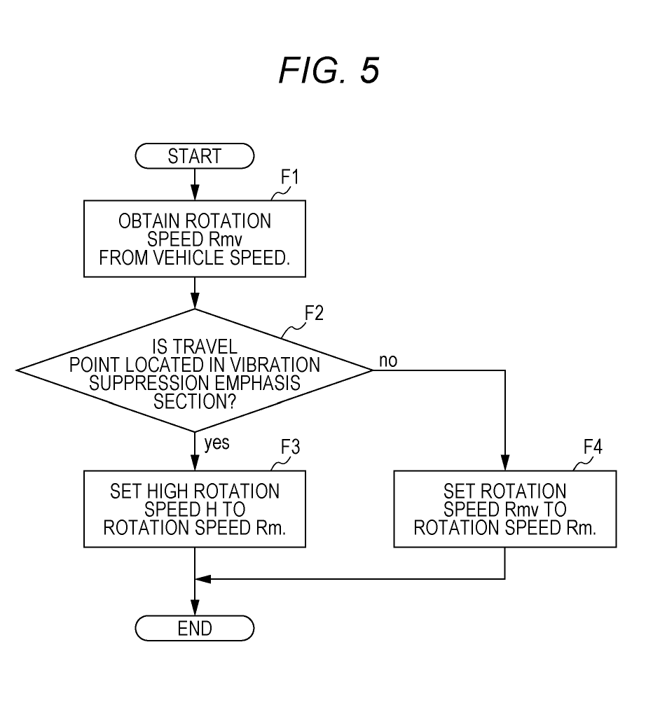

The process of the rotation speed determination unit 422 will be described with reference to the flowchart illustrated in FIG. 5. The rotation speed determination unit 422 determines whether the travel point is the vibration suppression emphasis section (step F2) by obtaining the rotation speed Rmv from the vehicle speed (step F1). When the travel point is the vibration suppression emphasis section as a determination result, the high rotation speed H is set to the rotation speed Rm (step F3). In contrast, when the travel point is not the vibration suppression emphasis section, the rotation speed Rmv is set to the rotation speed Rm (step F4). By repeating the above-described process, the rotation speed determination unit 422 determines the rotation speed Rm.

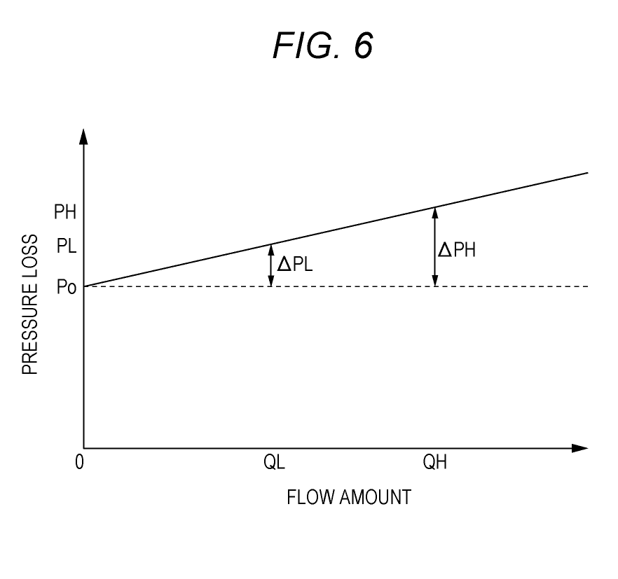

The current amount calculation unit 423 obtains the current amount I to be supplied to the electromagnetic relief valve 22 based on the control force F and the rotation speed Rm obtained as described above. Here, the electromagnetic relief valve 22 has a characteristic with a pressure override in which the valve opening pressure changes in proportion to the supplied current amount, but pressure loss increases in response to the passage flow amount as shown in FIG. 6. As indicated by the solid line of FIG. 6, when a certain current amount is supplied to the electromagnetic relief valve 22, there is a difference between pressure loss PH when a discharge flow amount QH discharged from the pump 12 rotating at the high rotation speed H passes through the electromagnetic relief valve 22 and pressure loss PL when a discharge flow amount QL discharged from the pump 12 rotating at the low rotation speed L passes through the electromagnetic relief valve 22. That is, when the rotation speed Rm of the pump 12 is different, the pressure of the rod side chamber 5 is not the same even when the valve opening pressure of the electromagnetic relief valve 22 is the same. Here, in the current amount calculation unit 423, in this example, two calculation equations are provided in response to the rotation speed Rm determined by the rotation speed determination unit 422. Specifically, two calculation equations are provided such that one equation corresponds to the low rotation speed L and the other equation corresponds to the high rotation speed H. The control force F is proportional to the pressure loss P of the electromagnetic relief valve 22 and F=A·P (A indicates the pressure receiving area of the piston 3) is established. Further, the pressure override ΔPL when the pump 12 rotates at the low rotation speed L and the pressure override ΔPH when the pump 12 rotates at the high rotation speed H are values which can be recognized in advance. Thus, when the valve opening pressure of the electromagnetic relief valve 22 receiving the supply of the certain current amount is indicated by Po, the control force F has a relationship of F=A·(Po+ΔPL) in a case in which the pump 12 is rotationally driven at the low rotation speed L and the control force F has a relationship of F=A·(Po+ΔPH) in a case in which the pump 12 is rotationally driven at the high rotation speed H. Further, the valve opening pressure Po and the current amount I supplied to the electromagnetic relief valve 22 are proportional to each other and Po=K·I (K is a constant) is established. With this relationship, the current amount calculation unit 423 may obtain the current amount I by I={F/A−ΔPL}/K when the pump 12 is rotationally driven at the low rotation speed L and may obtain the current amount I by I={F/A−ΔPH}/K when the pump 12 is rotationally driven at the high rotation speed H. That is, in this example, the current amount calculation unit 423 obtains the current amount I by using a calculation equation corresponding to the low rotation speed L when the rotation speed Rm determined by the rotation speed determination unit 422 is the low rotation speed L or using a calculation equation corresponding to the high rotation speed H when the rotation speed Rm is the high rotation speed H.

Additionally, the pump 12 has a tendency that the pump efficiency (the discharge flow amount with respect to the rotation speed Rm) decreases when the rotation speed Rm decreases. In a case in which a ratio between the rotation speed Rm and ΔPL is not the same as a ratio between the rotation speed Rm and ΔPH, that is, the rotation speed Rm is switched to two stages of the low rotation speed L and the high rotation speed H as in this example, it is possible to accurately control the thrust of the actuator A when two equations are provided. Additionally, one calculation equation corresponding to one of the high and low rotation speeds may be provided without preparing two calculation equations and the current amount I corresponding to the other rotation speed may be obtained. In that case, the current amount I may be simply obtained by previously obtaining a coefficient from a ratio between the current amount corresponding to one rotation speed and the current amount corresponding to the other rotation speed and multiplying the coefficient by the current amount obtained from the calculation equation corresponding to one rotation speed.

In this example, the relief valve control unit 425 is configured as a driver which drives a solenoid (not illustrated) of the electromagnetic relief valve 22 and the current amount calculation unit 423 receives the input of the current amount I and supplies a current to the electromagnetic relief valve 22 by a current amount indicated by the current amount I.

The motor driver 426 drives the pump 12 by supplying a current to the motor 15. In this example, the motor driver 426 drives the motor 15 so that the rotation speed of the pump 12 becomes the rotation speed Rm by PWM control. Thus, the motor driver 426 supplies a current to the motor 15 so that the pump 12 rotates at the low rotation speed L when the low rotation speed L is selected as the rotation speed Rm and supplies a current to the motor 15 so that the pump 12 rotates at the high rotation speed H when the high rotation speed H is selected as the rotation speed Rm.

Additionally, as hardware resources, although not illustrated in the drawings, the control unit C may specifically include, for example, an A/D converter which receives an signal output from the acceleration sensor 40, a storage device such as a read only memory (ROM) which receives the lateral acceleration a filtered by the band pass filter 41 and stores a program used for a process necessary for controlling the actuator A, a calculation device such as a central processing unit (CPU) which performs a process based on the program, and a storage device such as a random access memory (RAM) which provides a storage region to the CPU and the components of the control processing unit 42 of the control unit C can be realized by the execution of the program of the CPU. Further, the band pass filter 41 may be realized by the execution of the program of the CPU.

In this way, the railway vehicle vibration damping device 1 switches the rotation speed Rm of the pump 12 from the low rotation speed L to the high rotation speed H when the vehicle speed of the railway vehicle changes from a value smaller than the first threshold value α to a value equal to or larger than the first threshold value α and switches the rotation speed Rm of the pump 12 from the high rotation speed H to the low rotation speed L when the vehicle speed changes from a value equal to or larger than the second threshold value β to a value smaller than the second threshold value β. Thus, the railway vehicle vibration damping device 1 can decrease the rotation speed Rm of the pump 12 when the traveling sound is low due to the low vehicle speed of the railway vehicle and can increase the rotation speed Rm of the pump 12 when the traveling sound is large due to the high vehicle speed of the railway vehicle.

Since the rotation speed Rm of the pump 12 can be set to be low in a state in which the vehicle speed is low, noise generated inside the vehicle by the pump 12, the motor 15, and the cylinder body Cy can be decreased and hence the passenger does not recognize noise. Further, since the vibration of the vehicle body B also tends to decrease and the flow amount necessary for the cylinder body Cy also decreases when the vehicle speed is low, the actuator A can exert the thrust sufficiently suppressing the vibration of the vehicle body B even when the rotation speed Rm of the pump 12 is set to be low.

In a state in which the vehicle speed is high, the rotation speed Rm of the pump 12 is set to be high. However, since the traveling sound increases, the passenger does not recognize noise generated by the pump 12, the motor 15, and the cylinder body Cy. Further, in a state in which the vehicle speed is high, the vibration of the vehicle body B tends to be strong. However, since the rotation speed Rm of the pump 12 also increases, the actuator A can exert a thrust capable of sufficiently suppressing the vibration of the vehicle body B.

As described above, since the railway vehicle vibration damping device 1 of the invention includes the actuator A and the control unit C which controls the pump 12 and controls the rotation speed Rm of the pump 12 based on the vehicle speed of the railway vehicle, an effect of suppressing vibration of the vehicle body B is not impaired and the passenger does not recognize noise. Thus, the railway vehicle vibration damping device 1 of the invention can improve the ride comfort of the vehicle.

Regarding the control of the rotation speed Rm of the pump 12, a method of installing a sensor detecting a noise amount inside a vehicle and increasing the rotation speed Rm of the pump 12 when the noise amount exceeds a predetermined level can be also supposed. However, in the case of such a method, there is a case in which the noise amount is low even when the vehicle runs at a high speed. In that case, even when the actuator A needs to exert a large thrust, the rotation speed Rm of the pump 12 remains low, so that the vibration suppressing effect cannot be sufficiently obtained. Regarding this point, as in the invention, when the rotation speed Rm of the pump 12 is determined based on the vehicle speed, it is possible to realize the effect of suppressing the vibration of the vehicle body B and the noise recognition suppressing effect at the same time.

Further, in the railway vehicle vibration damping device 1 of this example, the rotation speed Rm of the pump 12 is set to a predetermined low rotation speed L when the vehicle speed is smaller than the first threshold value α and the rotation speed Rm of the pump 12 is set to a predetermined high rotation speed H when the vehicle speed is equal to or larger than the first threshold value α. In this way, in the railway vehicle vibration damping device 1 of this example, the rotation speed Rm of the pump 12 is switched in two high and low stages. Thus, a signal indicating the rotation speed Rm of the pump 12 becomes two kinds of high and low values. Accordingly, since the control of the rotation speed of the pump 12 is not easily influenced even when noise is superimposed on the signal, it is possible to realize high-robust control which is strong against noise. In addition, when the vehicle speed increases at the time of switching the rotation speed of the pump 12, the rotation speed Rm of the pump 12 may be gradually increased in three stages or more. In this case, a calculation equation for obtaining the current amount I for each stage of the rotation speed Rm may be prepared and the current amount I may be obtained by the current amount calculation unit 423. Further, when the vehicle speed becomes equal to or larger than the first threshold value α, the rotation speed Rm of the pump 12 may be changed from the low rotation speed L to the high rotation speed H in proportion to the vehicle speed. In this case, an equation for obtaining the current amount I may be set as I={F/A−X}/K and the value of X may be changed by using the rotation speed Rm as a parameter. Then, X may be obtained by a map calculation and the current amount I may be obtained by the current amount calculation unit 423.

Further, in the railway vehicle vibration damping device 1 of this example, the rotation speed Rm of the pump 12 is switched from the low rotation speed L to the high rotation speed H when the vehicle speed changes from a value smaller than the first threshold value α to a value equal to or larger than the first threshold value α and the rotation speed Rm of the pump 12 is switched from the high rotation speed H to the low rotation speed L when the vehicle speed changes from a value equal to or larger than the second threshold value β smaller than the first threshold value α to a value smaller than the second threshold value β. That is, a change in the rotation speed Rm of the pump 12 has hysteresis with respect to the vehicle speed. When the railway vehicle vibration damping device 1 has such a configuration, there is no hunting in which the low rotation speed L and the high rotation speed H are switched at a high frequency even when the vehicle speed changes oscillatingly in the vicinity of the first threshold value α or the second threshold value β. Since the occurrence of hunting is prevented, an oscillating change in the rotation speed Rm of the pump 12 is suppressed and an oscillating change in the thrust of the actuator A can be prevented. Accordingly, the ride comfort of the vehicle can be further improved. Further, since there is no hunting, there is no need to frequently perform the operation of switching the rotation speed Rm of the pump 12 and it is possible to prevent a problem in which the vibration damping device is not economical due to the early deterioration of the pump 12 and the motor 15 for driving the pump 12.

Then, in the railway vehicle vibration damping device 1 of this example, when the travel point of the railway vehicle is a point in which the rotation speed Rm of the pump 12 should be a high speed, the rotation speed Rm of the pump 12 is set to a high speed regardless of the vehicle speed. In the railway vehicle vibration damping device 1 with such a configuration, since the pump is rotated at a high speed when the travel point is a vibration suppression emphasis section corresponding to a point in which the rotation speed Rm should be a high speed, the pump 12 is rotated at a high speed in a state in which a large thrust needs to be exerted on the actuator A and hence the vibration of the vehicle body B can be reliably suppressed.

Further, the railway vehicle vibration damping device 1 of this example includes the electromagnetic relief valve 22 which adjusts the pressure inside the cylinder body Cy and obtains the current amount given to the electromagnetic relief valve 22 by using a pressure override based on the rotation speed Rm of the pump 12. In the railway vehicle vibration damping device 1 with such a configuration, it is possible to accurately control the thrust of the actuator A regardless of a change in pump efficiency of the pump 12.

While the preferred embodiments of the invention have been described in detail, improvements, modifications, and changes can be made without departing from the scope of the claims.

This application claims priority based on Japanese Patent Application No. 2016-149989 filed on Jul. 29, 2016 in Japan Patent Office, the entire contents of which are incorporated herein by reference.

1. A railway vehicle vibration damping device comprising:
an actuator which includes a cylinder body expanding or contracting by supply of a hydraulic fluid and a pump supplying the hydraulic fluid to the cylinder body and is provided in a railway vehicle; and
a control unit which controls the pump,
wherein the control unit controls a rotation speed of the pump based on a vehicle speed of the railway vehicle.

2. The railway vehicle vibration damping device according to claim 1,
wherein a low rotation speed is set for the rotation speed of the pump in advance,
wherein a high rotation speed which is higher than the low rotation speed is set for the rotation speed of the pump in advance,
wherein a first threshold value is set for the vehicle speed in advance,
wherein the control unit switches the rotation speed of the pump from the high rotation speed to the low rotation speed when the vehicle speed changes from a value equal to or larger than the first threshold value to a value smaller than the first threshold value and switches the rotation speed of the pump from the low rotation speed to the high rotation speed when the vehicle speed changes from a value smaller than the first threshold value to a value equal to or larger than the first threshold value.

3. The railway vehicle vibration damping device according to claim 1,
wherein the control unit gradually increases the rotation speed of the pump when the vehicle speed increases.

4. The railway vehicle vibration damping device according to claim 1,
wherein the control unit increases the rotation speed of the pump in proportion to an increase in vehicle speed.

5. The railway vehicle vibration damping device according to claim 1,
wherein a low rotation speed is set for the rotation speed of the pump in advance,
wherein a high rotation speed which is higher than the low rotation speed is set for the rotation speed of the pump in advance,
wherein a first threshold value is set for the vehicle speed in advance,
wherein a second threshold value which is smaller than the first threshold value is set for the vehicle speed in advance, and
wherein the control unit switches the rotation speed of the pump from the low rotation speed to the high rotation speed when the vehicle speed changes from a value smaller than the first threshold value to a value equal to or larger than the first threshold value and changes the rotation speed of the pump from the high rotation speed to the low rotation speed when the vehicle speed changes from a value equal to or larger than the second threshold value to a value smaller than the second threshold value.

6. The railway vehicle vibration damping device according to claim 1,
wherein travel point information of the railway vehicle is input to the control unit,
wherein a section that rotates the pump at a high speed is set for a travel point of the railway vehicle, and
wherein the control unit rotates the pump at a high rotation speed regardless of the vehicle speed when determining that the railway vehicle travels in the section.

7. The railway vehicle vibration damping device according to claim 1, further comprising:
an electromagnetic relief valve which adjusts a pressure inside the cylinder body,
wherein the control unit controls a thrust exerted on the cylinder body by a current amount given to the electromagnetic relief valve and obtains the current amount by using a pressure override based on the rotation speed of the pump.
